(19) United States
(12) Patent Application Publication
(10) Pub. No.: US 2014/0237153 A1
(43) Pub. Date: Aug. 21, 2014

(54) DEVICE-READY-STATUS TO FUNCTION-READY-STATUS CONVERSION

(71) Applicant: NVIDIA CORPORATION, Santa Clara, CA (US)

(72) Inventors: Stephen David GLASER, San Francisco, CA (US); Christian Edward RUNHAAR, Austin, TX (US)

(73) Assignee: NVIDIA CORPORATION, Santa Clara, CA (US)

(21) Appl. No.: 13/769,135

(22) Filed: Feb. 15, 2013

(51) Int. Cl. G06F 13/40

(52) U.S. Cl. CPC G06F 13/4027
USPC 710/313

(57) ABSTRACT

A method for sending readiness notification messages to a root complex in a peripheral component interconnect express (PCIe) subsystem. The method includes receiving a device-ready-status (DRS) message in a downstream port that is coupled to an upstream port in a PCIe component. The method further includes setting a bit in the downstream port indicating that the DRS message has been received.

### BACKGROUND OF THE INVENTION

1. Field of the Invention

The present invention generally relates to Peripheral Component Interconnect (PCI) Express (or PCIe), and, more particularly, to device-ready-status to function-ready-status conversion.

2. Description of the Related Art

Peripheral Component Interconnect (PCI) Express (or PCIe) is a serial computer expansion bus standard that uses point-to-point communication and data routing. A root complex provides an interface between PCIe components and the central processing unit (CPU) and system memory. The root complex may be coupled to components such as switches and PCIe endpoint devices. Switches route data between the root complex and other PCIe components such as endpoint devices. Each switch may be coupled to one or more PCI Express endpoint device. All components in a PCIe network, including switches, endpoint devices, and the root complex, have one or more “Functions” that are directly addressable by components in the PCIe network. Functions, such as those within switches and endpoint devices, are assigned addresses and identifiers so that traffic may be addressed to and transmitted to a particular Function.

When a system with a PCIe bus is powered on, or when an individual PCIe endpoint device is powered on, reset, or brought from a low-power mode to a full-power mode, the Basic Input/Output System (BIOS) or operating system typically sends configuration requests to Functions within the PCIe network, such as the Functions in PCIe endpoint devices, to configure the Functions for normal operation. However, prior to such configuration, to allow components time for initialization or warm-up, the BIOS or operating system follows a delay rule that mandates a specific delay period during which the BIOS or operating system cannot send configuration requests to components. One drawback of obeying the delay rule is that the delay lasts a relatively long time (typically one second) and, therefore, may hinder the quick configuration of components.

In some implementations, the BIOS or operating system can be configured to ignore the delay rule and send configuration requests to the different components before the end of the delay period. However, a component may respond to configuration requests with a “Configuration Retry Status” (CRS) message if the component has not yet completed initialization. In such situations, the BIOS or operating system typically polls the component until the component does not respond with a CRS message. One drawback of polling components is that the BIOS or operating system may not be informed of the actual time at which components are available. Thus, the BIOS or operating system must wait until either the delay period expires or until the component does not return a CRS message to begin configuring the component. This may result in longer startup times for the components, and for the computer system as a whole. An additional drawback of polling the PCIe endpoint device is that, the BIOS or operating system must still wait 100 milliseconds prior to an initial configuration request. Thus even with polling, the BIOS or operating system may not be informed of the actual time at which components are available, which may result in longer startup times for the components and for the computer system as a whole.

As the foregoing illustrates, what is needed in the art is a more effective way to configure PCI Express endpoint devices within a computing system.

### SUMMARY OF THE INVENTION

One embodiment of the present invention sets forth a method for sending readiness notification messages to a root complex. The method includes receiving a device-ready-status (DRS) message in a downstream port that is coupled to an upstream port in a peripheral component interconnect express (PCIe) component. The method further includes setting a bit in the downstream port indicating that the DRS message has been received.

Other embodiments include, without limitation, a computer-readable medium that includes instructions that enable a processing unit to implement one or more aspects of the disclosed methods. Other embodiments include, without limitation, a subsystem that includes a processing unit configured to implement one or more aspects of the disclosed methods as well as a computing device configured to implement one or more aspects of the disclosed methods.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 depicts a peripheral component express (PCIe) subsystem, according to one embodiment of the present invention;

FIG. 3 illustrates a first exchange between PCIe endpoint device, switch, and root complex, according to one embodiment of the present invention;

FIG. 4 illustrates a second exchange between PCIe endpoint device, switch, and root complex, according to another embodiment of the present invention; and

FIG. 5 is a flow diagram of method steps for transmitting readiness notification messages within PCIe subsystem, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

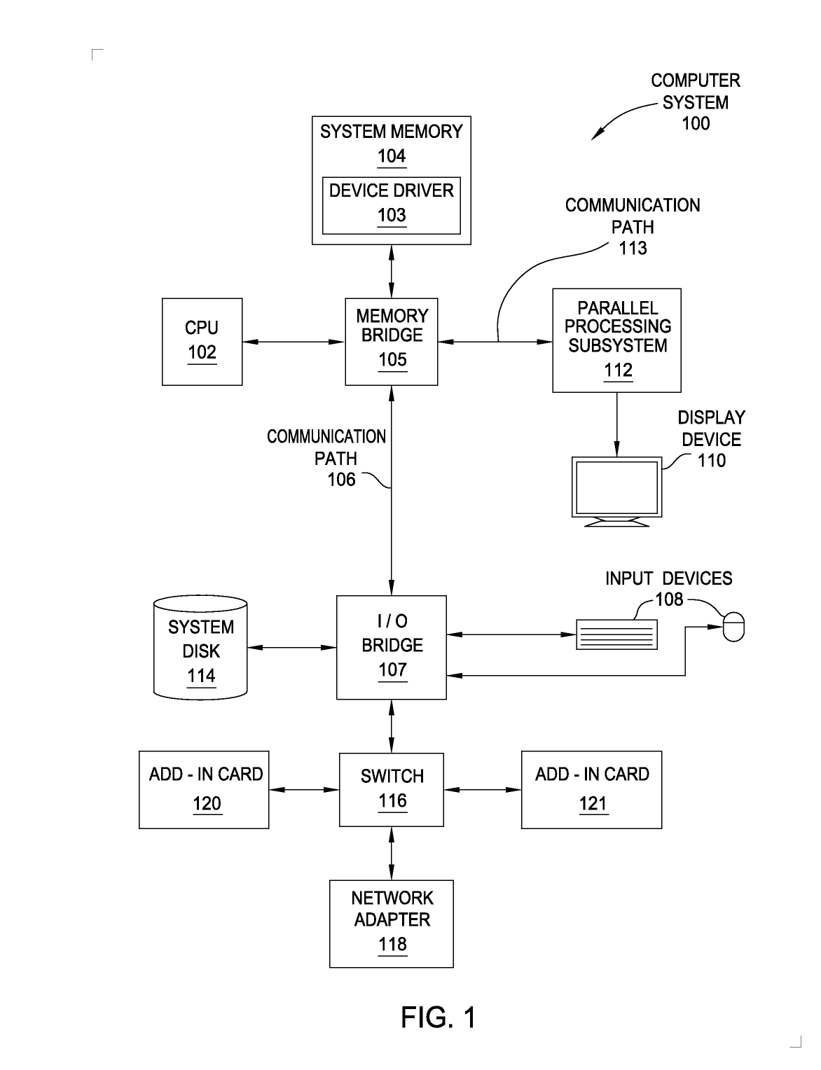

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105. A parallel processing subsystem 112 is coupled to memory bridge 105 via a bus or second communication path 113 (e.g., a Peripheral Component Interconnect (PCI) Express, Accelerated Graphics Port, or HyperTransport link); in one embodiment parallel processing subsystem 112 is a graphics subsystem that delivers pixels to a display device 110 that may be any conventional cathode ray tube, liquid crystal display, light-emitting diode display, or the like. A system disk 114 is also connected to I/O bridge 107 and may be configured to store content and applications and data for use by CPU 102 and parallel processing subsystem 112. System disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices.

A switch 116 provides connections between I/O bridge 107 and other components such as a network adapter 118 and various add-in cards 120 and 121. Other components (not explicitly shown), including universal serial bus (USB) or other port connections, compact disc (CD) drives, digital versatile disc (DVD) drives, film recording devices, and the like, may also be connected to I/O bridge 107. The various communication paths shown in FIG. 1, including the specifically named communication paths 106 and 113 may be implemented using any suitable protocols, such as PCI Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing subsystems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

### Peripheral Component Interconnect Express (PCIe) Subsystem

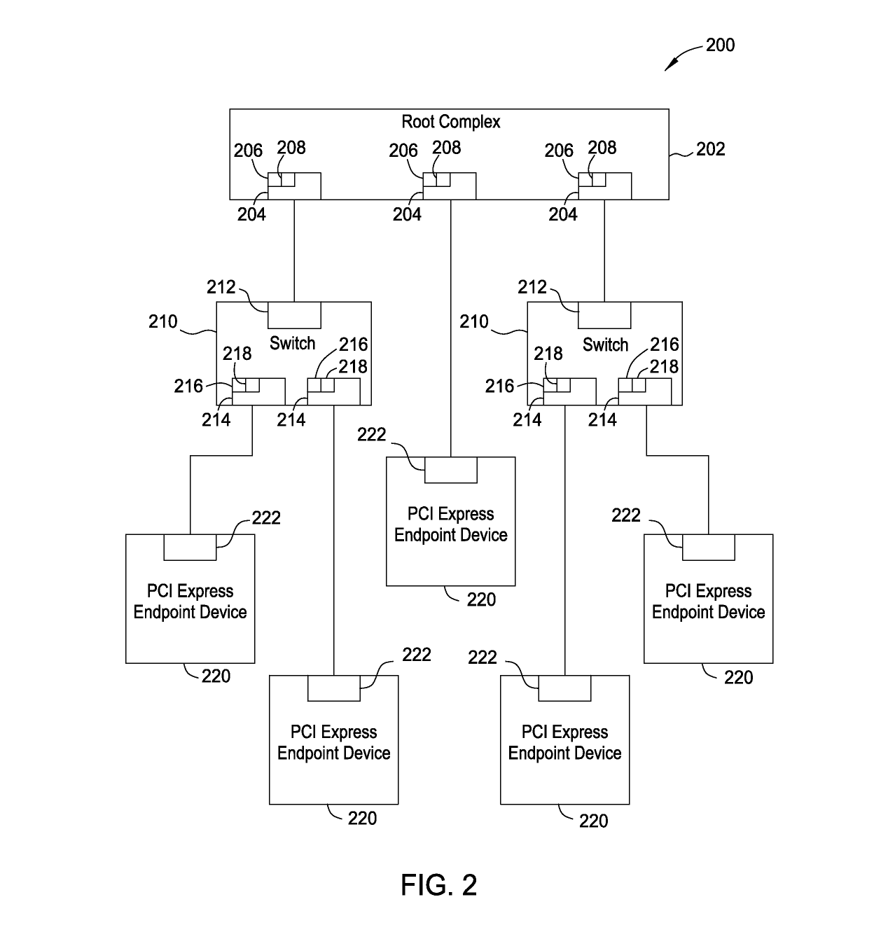

FIG. 2 depicts a peripheral component express (PCIe) subsystem 200, according to one embodiment of the present invention. As shown, the PCIe subsystem 200 includes “components” such as root complex 202, switches 210, and PCIe endpoint devices 220.

In PCIe subsystem 200, root complex 202 provides a communication pathway between CPU 102, system memory 104, and PCIe endpoint devices 220. PCIe endpoint devices 220 provide various types of functionality to computer system 100, such as networking functionality, graphics functionality, and the like. PCIe endpoint devices 220 implement at least one “Function” that can be accessed. Switches 210 provide communication pathways between root complex 202 and PCIe endpoint devices 220.

Within PCIe subsystem 200, information generally flows through “links.” A link is a point-to-point communication channel between two components in PCIe subsystem 200, and more specifically, between an upstream port in a component and a downstream port in another component. Upstream ports are ports such as upstream ports 212 in switches 210 and upstream ports 222 in PCIe endpoint device. Downstream ports are ports such as downstream port 204 in root complex 202, and downstream ports 214 in switches. The term “upstream” refers to the direction of towards root complex 202. The term “downstream” refers to the direction of away from root complex 202.

Some examples of links in PCIe subsystem 200 include links formed between root complex 202 and switches 210 via downstream port 204 and upstream port 212, links between downstream port 204 in root complex 202 and upstream port 222 in PCIe endpoint device 220, and links between downstream ports 214 in switches 210 and upstream ports 222 in PCIe endpoint devices 220.

To send information from one component to another component, information is sent such that the information flows through links that trace a path between the two components. For example, PCIe endpoint device 220 sends information to root complex 202 by sending the information first to switch 210, along with an indication that the information is intended for root complex 202. When switch 210 receives the information, switch 210 “retransmits” the information to the root complex 202. When a component such as switch 210 “retransmits” data that switch 210 receives from PCIe endpoint device 220, the component may be said to “forward” the data from PCIe endpoint device 220 to root complex 202.

A component indicates a destination for information by indicating an “address” or an “identifier” (“ID”) of another component. Addresses and identifiers are two independent ways in which components within PCIe subsystem 200 are accessed. An address is a value that that indicates an address space (e.g., in memory) to which a component is mapped. An identifier is a value that indicates a “geographical” location of a component. A “geographical location” is a location that indicates a bus number, a device number, and a Function number, which together uniquely identify a Function on a PCIe component within a hierarchy. PCIe components, including PCIe endpoint devices, implement one or more function, each of which can be accessed by “identifier.”

As is recognized, large embodiments may include multiple PCIe subsystems, each including a collection of root ports and root complex integrated endpoints. A hierarchy is a tree-structured collection of Functions that share a single bus/device/function number space. Typically, components can only utilize an “identifier” to indicate a destination for information for other components within the same hierarchy. Within switches 210, downstream ports 214 and upstream ports 212 generally have their own function number. Upstream ports may have more than one function, including endpoint functions as well as upstream switch ports. Upstream switch ports are ports that perform switching functionality (i.e., retransmit data to a downstream component), while endpoint functions may perform other functionality, such as non-switch related functionality. Any type of component in PCIe subsystem 200 may be accessed geographically or by address.

Many types of communications are possible between components in PCIe subsystem 200. One type of communication that is possible is the sending of “messages.” Message have a routing type such as link local routing and route-to-root routing.

With link local routing, one component sends a message to another component through a link. A component that receives a message that is sent with link local routing is not required to forward that message to another component. A component that receives a link local message can take whatever actions the component is configured to take with respect to the link local message. In other words, in link local routing, a component sends a message from the component's downstream port or upstream port through a link to another component's downstream or upstream port. For example, in PCIe subsystem 200, if PCIe endpoint device 220 sends a link local message to switch 210, the link local message is sent from upstream port 222 in PCIe endpoint device 220 to downstream port 214 in switch 210. Switch 210 does not necessarily take any further action with respect to the link local message received by switch 210.

With route-to-root routing, one component sends a message to another component through a link and the component that receives the message forwards the message to the root complex. A component that receives a message that is sent with route-to-root routing forwards that message until the message arrives at the root complex. A route-to-root message is thus recursively forwarded by each component that receives the route-to-root message until the route-to-root message arrives at the root complex. In other words, when a component receives a route-to-root message, the component forwards the message to an upstream component. If the upstream component is not the root complex, the upstream component forwards the message to another upstream component. The process of forwarding the route-to-root message continues until the route-to-root message arrives at the root complex. For example, in PCIe subsystem 200, if PCIe endpoint device 220 sends a route-to-root message to switch 210, the route-to-root message is sent from upstream port 222 in PCIe endpoint device 220 to downstream port 214 in switch 210. Then, switch 210 sends the message from upstream port 212 in switch 210 to downstream port 204 in root complex 202. Since the message is at root complex 202, forwarding of the message stops.

### Readiness Notification

Generally, when computer 100 is operating normally, components within PCIe subsystem 200, such as PCIe endpoint devices 220, are fully powered and are operating normally. For example, a PCIe endpoint device 220 having network capabilities communicates with an external network on behalf of a CPU and/or other computer components, while the PCIe endpoint device 220 with network capabilities is operating normally. However, components such as PCIe endpoint devices 220 may experience status change conditions, such as being switched on, being fully or partially reset, transitioning from a low-power state to high-power state, or some other status change conditions.

After some status change conditions, components such as PCIe endpoint devices 220 are not necessarily ready for normal operation immediately after the status change condition. For example, when computer system 100 or PCIe endpoint devices 220 are powered on, components such as PCIe endpoint devices 220 may require a “warm-up” time to initialize hardware, or to perform other warm-up related functions. Further, after some status change conditions, components such as PCIe endpoint devices 220 do not have valid addresses or identifiers. For example, when a computer system 100 is powered on, PCIe endpoint devices 220 may not have valid addresses or identifiers, and therefore PCIe endpoint devices 220 cannot be addressed by addresses or identifiers.

Addresses and identifiers are assigned to components in PCIe subsystem 200 such as PCIe endpoint devices 220 by root complex 202 in a process referred to as “enumeration,” in which root complex 202 sends configuration requests to components in a PCIe subsystem 200 such as PCIe endpoint devices 220. Components other than PCIe endpoint devices 220, such as switches 210 may also require enumeration and configuration upon being powered on or in the event of another status change condition.

Components such as PCIe endpoint devices 220 may not be ready to process configuration requests after a status change condition. For example, if root complex 202 sends a configuration request to a PCIe endpoint device 220, and PCIe endpoint device 220 is not ready to process configuration requests, then the PCIe endpoint device 220 may respond to configuration requests with a “configuration retry status” (CRS) message. However, to inform root complex 202 of when a component such as PCIe endpoint device 220 is ready to receive configuration requests, a component such as PCIe endpoint device 220 also has the option to send one of two types of readiness notification (“RN”) messages upstream.

A first type of RN message is a function-ready-status (FRS) message. A component such as PCIe endpoint device 220 has the option to transmit an FRS message upstream when a function of the PCIe endpoint device 220 becomes available. FRS messages have route-to-root routing. In some embodiments, FRS messages include a “reason field” that indicates a reason for which the FRS message is sent. In some embodiments, the reason field may indicate that the FRS message is generated due to a low-power-to-high-power transition, a function-level reset, or other reasons. Functions other than those in PCIe endpoint devices 220 may transmit FRS messages. For example, a function in an upstream port in a switch may transmit an FRS message.

When a component such as PCIe endpoint device 220 sends an FRS message, the FRS message is forwarded until the FRS message arrives at the root complex 202. For example, if PCIe endpoint device 220 sends a FRS message to switch 210, switch 210 then forwards the FRS message to root complex 202. The FRS message includes an identifier indicating a bus, device and function. Upon receiving the FRS message, root complex 202 examines the contents of the FRS message, which may indicate, for example, that the component that transmitted the FRS message is ready, or may indicate other information.

A second type of RN message is a device-ready-status (DRS) message. A component such as PCIe endpoint device 220 has the option to transmit a DRS message upstream when all functions of the PCIe endpoint device 220 are ready. DRS messages have link local routing.

In some embodiments, FRS messages and DRS messages are configured as “vendor defined messages,” meaning that the FRS messages and DRS messages include a field that indicates a particular “vendor” or manufacturer. Further, in some embodiments, FRS messages and DRS messages are “type 1” vendor defined messages, meaning that a component that receives the messages and does not know what to do with the messages may silently discard the message.

### Device-Ready-Status-to-Function-Ready-Status Conversion

Because a component such as PCIe endpoint device 220 can transmit a DRS message prior to the PCIe endpoint device 220 knowing the PCIe endpoint device's 220 ID or address, a downstream port 214 in a switch 210 or a downstream port 204 in a root complex 202 that receives a DRS message has the option to perform device-ready-status-to-function-ready-status (DRS-to-FRS) conversion. When a switch 210 performs a DRS-to-FRS conversion, a downstream port 214 in a switch 210 receives a DRS message and in response sends an FRS message upstream to root complex 202. The FRS message includes the ID or address of the downstream port 214 that receives the DRS message. Although the FRS message does not indicate the ID or address of the PCIe endpoint device 220 that sends the DRS message, root complex 202 “knows” that the downstream port 214 that receives the DRS message is coupled to an operating PCIe endpoint device 220. DRS-to-FRS conversion is discussed in more detail below.

Downstream ports 214 in switches 210 have a DRS received bit 216 and a DRS-to-FRS conversion enable bit 218. Initially, that is, upon power on or reset of the PCIe subsystem 200, or whenever the link below the downstream port 214 goes down, DRS message received bit 216 has a value of 0 (also referred to as “unset” or “not set”). When switch 210 receives a DRS message in a downstream port 214 that is connected to a PCIe endpoint device 220, switch 210 changes the value of DRS received bit 218 in the downstream port 214 that received the DRS message to 1 (also referred to as “set”). A set DRS received bit thus indicates that the downstream port 214 received a DRS message from the component that is coupled to the downstream port 214.

A switch 210 with a DRS-to-FRS conversion enable bit 218 having a value of 1 “converts” a received DRS message to an FRS message. More specifically, when a switch 210 receives a DRS message, if the DRS-to-FRS conversion enable bit 218 is set, switch 210 generates an FRS message and sends the FRS message from upstream port 212 upstream. Because the FRS message has route-to-root routing, any component that receives the FRS forwards the FRS message upstream until the FRS message arrives at root complex 202. When root complex 202 receives the FRS message, root complex 202 is informed that the downstream port 214 in the switch 210 received the DRS message from a component. Root complex 202 is therefore informed that the component generated a DRS message.

The FRS message generated by switch 210 includes an indication of the identification of the downstream port 214 that receives the original DRS message. The identification of this downstream port 214 provides an indication of the component that is connected to the downstream port 214, even if the component did not send a valid requestor ID to the switch 210 that received the original DRS message. By identifying the downstream port 214 that receives the original DRS message, the FRS message that is sent upstream to root complex 202 indicates that the component coupled to the downstream port 214 that is identified is ready.

A switch 210 with a DRS-to-FRS conversion enable bit 218 having a value of 0 does not “convert” a received DRS message to an FRS message. Rather, the DRS message received bit 216 is simply set to 1, indicating that a DRS message is received from a component. The DRS message received bit 216 remains set and when root complex 202 communicates with switch 210, root complex learns that a component coupled to the downstream port 214 of the switch 210 sent a DRS message to switch 210.

Root complex also has downstream ports 204 that may be directly coupled to PCIe endpoint devices 220. Downstream ports 204 have DRS message received bit 206 and DRS-to-FRS conversion enable bit 208 which operate similarly to bits 216 and 218. More specifically, if downstream port 204 receives a DRS message from PCIe endpoint device 220, downstream port 204 sets DRS message received bit 206. If DRS-to-FRS conversion enable bit 208 is set, then downstream port 204 converts the DRS message to an FRS message and sends FRS message to root complex 202.

It will be appreciated that the architecture described herein is illustrative only and that variations and modifications are possible. In one example, switches 210 may be arranged in more than one level. In other words, downstream ports in some switches may be connected to upstream ports in other switches. In another example, upstream ports in switches may have multiple Functions, such as endpoint Functions, multiple upstream switch ports, and other Functions. Additionally, Functions in any components, such as switches, may be configured with readiness notification functionality, such as the ability to transmit DRS messages or FRS messages upstream.

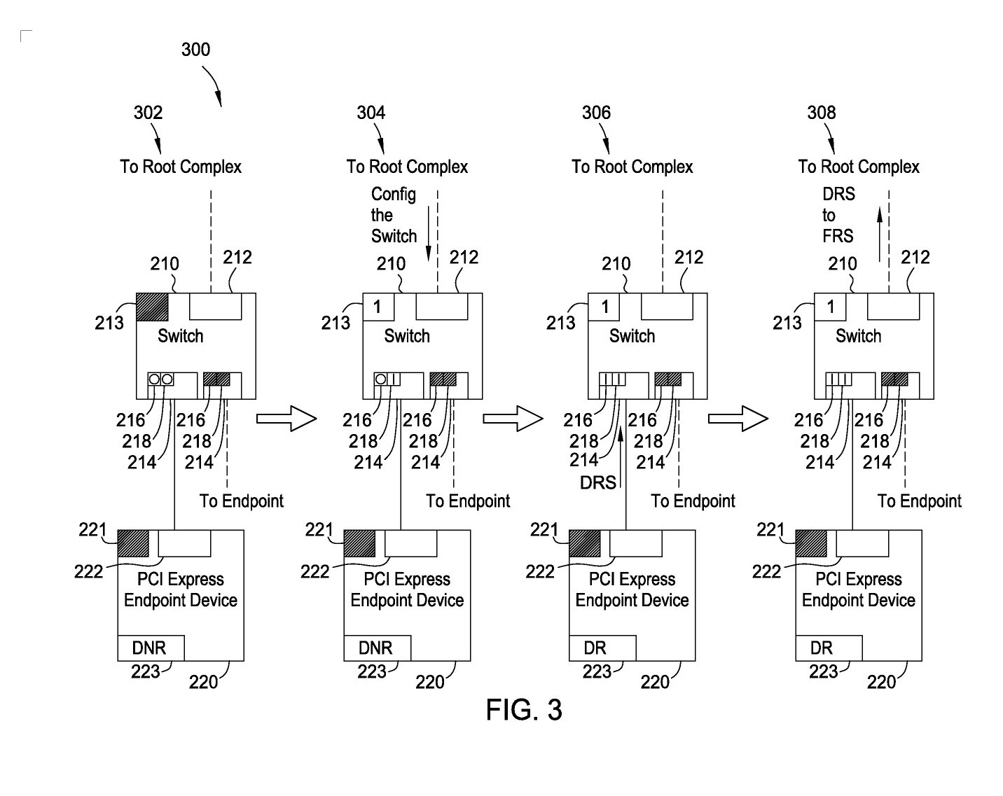

FIG. 3 illustrates a first exchange 300 between PCIe endpoint device 220, switch 210, and root complex 202, according to one embodiment of the present invention. As shown, the exchange 300 includes first state 302 of PCIe subsystem 200, second state 304 of PCIe subsystem 200, third state 306 of PCIe subsystem 200, and fourth state 308 of PCIe subsystem 200.

Exchange 300 depicts a series of transitions between states 302, 304, 306, and 308. Transitions happen after a period of time elapses, and certain actions are taken by various components within PCIe subsystem 200, as described in further detail below. In states 302, 304, 306, and 308, several components in PCIe subsystem 200 are not shown, for clarity.

In first state 302, PCIe endpoint device 220 has an identifier 221 that is not valid, and has a device state 223 of device not ready (“DNR”). Upstream port 222 of PCIe endpoint device 220 forms link with downstream port 214 of switch 210. Switch 210 has identifier 213 that is not valid, has two downstream ports 214, and has upstream port 212 that forms a link with root complex 202. Downstream port 214 has DRS message received bit 216 and DRS-to-FRS conversion enable bit 218. In downstream port 214 that forms link with PCIe endpoint device 220, both DRS message received bit 216 and DRS-to-FRS conversion enable bit 218 are set to 0. In downstream port 214 that forms link with PCIe endpoint device that is not shown, DRS message received bit 216 and DRS-to-FRS conversion enable bit 218 are not shown with any value, for clarity. After a certain period of time, PCIe subsystem 200 transitions from first state 302 to second state 304.

In second state 304, PCIe endpoint device 220 still has an identifier that is not valid. However, root complex 202 has issued instructions to configure switch 210, and so switch now has an identifier 213 of “1” (the identifier shown in this example is displayed as a single digit for clarity). Further, root complex 202 has issued instructions to switch 210 such that DRS-to-FRS conversion enable bit 218 in switch 210 is set to 1, indicating that switch 210 converts received DRS messages to FRS messages. After a certain period of time, PCIe subsystem 200 transitions from second state 304 to third state 306.

In third state 306, PCIe endpoint device 220 issues DRS message to switch 214. Upon receiving DRS message, downstream port 214 in switch 210 sets DRS message received bit 216. After a certain period of time, PCIe subsystem 200 transitions from third state 306 to fourth state 308.

In fourth state 308, switch 210 transmits an FRS message upstream. The transmitted FRS message has route-to-root routing, indicates that the FRS message is the result of a DRS-to-FRS message conversion, and indicates a requestor ID corresponding to downstream port 214 in switch 210 that received the original DRS message. The FRS message indicates to root complex 202 that the PCIe endpoint device 220 that forms a link with downstream port 214 in switch 210 sent the original DRS message and is therefore ready to accept configuration requests from root complex 202.

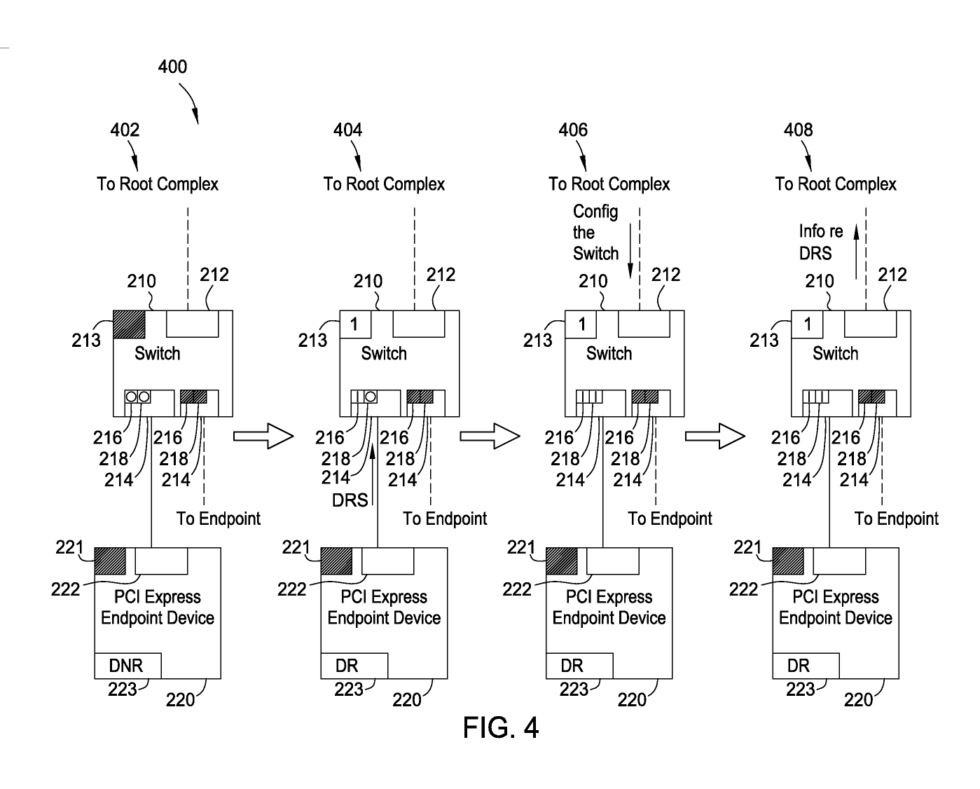

FIG. 4 illustrates a second exchange 400 between PCIe endpoint device 220, switch 210, and root complex 202, according to another embodiment of the present invention. As shown, the exchange 400 includes first state 402 of PCIe subsystem 200, second state 404 of PCIe subsystem 200, third state 406 of PCIe subsystem 200, and fourth state 408 of PCIe subsystem 200.

Exchange 400 depicts a series of transitions between states 402, 404, 406, and 408. Transitions happen after a period of time elapses, and certain actions are taken by various components within PCIe subsystem 200. In states 402, 404, 406, and 408, several components in PCIe subsystem 200 are not shown, for clarity.

In first state 402, PCIe endpoint device 220 has an identifier 221 that is not valid, and has a device state 223 of device not ready (“DNR”). Upstream port 222 of PCIe endpoint device 220 forms link with downstream port 214 of switch 210. Switch 210 has identifier 213 that is not valid, has two downstream ports 214, and has upstream port 212 that forms a link with root complex 202. Downstream port 214 has DRS message received bit 216 and DRS-to-FRS conversion enable bit 218. In downstream port 214 that forms link with PCIe endpoint device 220, both DRS message received bit 216 and DRS-to-FRS conversion enable bit 218 are set to O. In downstream port 214 that forms link with PCIe endpoint device that is not shown, DRS message received bit 216 and DRS-to-FRS conversion enable bit 218 are not shown with any value, for clarity. After a certain period of time, PCIe subsystem 200 transitions from first state 402 to second state 404.

In second state 404, PCIe endpoint device 220 still has an identifier that is not valid. However, PCIe endpoint device 220 has device state 223 of device ready (“DR”) and therefore sends DRS message to switch 210. Downstream port 214 in switch 210 sets DRS message received bit 216 to 1. After a certain period of time, PCIe subsystem 200 transitions from second state 404 to third state 406.

In third state 406, root complex 202 issues instructions to configure switch 210, and so switch now has an identifier 213 of “1” (the identifier shown in this example is displayed as a single digit for clarity). After a certain period of time, PCIe subsystem 200 transitions from third state 406 to fourth state 408.

In fourth state 408, switch 210 responds to the configuration requests from root complex 202 by informing root complex 202 that DRS message received bit 216 in downstream port 214 is set and therefore indicates that a DRS message has been received.

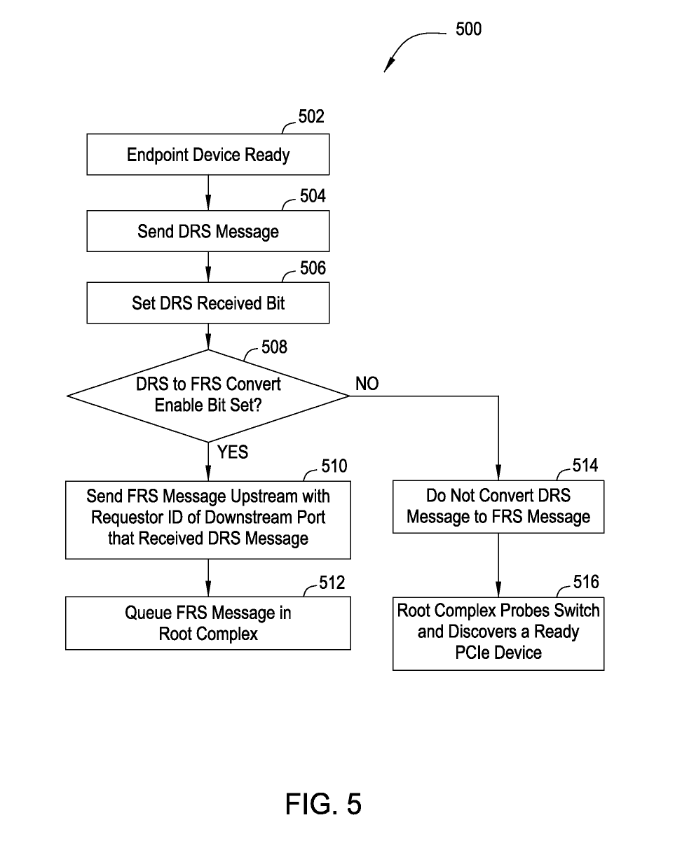

FIG. 5 is a flow diagram of method steps for transmitting readiness notification messages in PCIe subsystem 200, according to one embodiment of the present invention. Although the method steps are described in conjunction with FIGS. 1-4, persons skilled in the art will understand that any system configured to perform the method steps, in any order, falls within the scope of the present invention.

As shown, a method 500 begins at step 502, where PCIe endpoint device 220 becomes ready. PCIe endpoint device 220 determines that PCIe endpoint device 220 is ready when PCIe endpoint device 220 determines that all functions in PCIe endpoint device 220 are ready to be configured. In step 504, PCIe endpoint device 220 sends DRS message upstream to indicate that PCIe endpoint device 220 is ready. In step 506, the switch 210 that receives the DRS message sets a DRS message received bit 216 to 1, indicating that a DRS message has been received by the switch 210.

In step 508, switch 210 determines whether the DRS-to-FRS conversion enable bit 218 is set. If the DRS-to-FRS message conversion enable bit 218 is set, the method 500 proceeds to step 510. In step 510, the switch 210 generates an FRS message and sends the FRS message upstream, along with an indication that the FRS message is the result of a DRS-to-FRS message conversion and the requestor ID of the downstream port 214 that received the original DRS message. The PCIe subsystem 200 sends the FRS message upstream to the root complex 202, which queues the FRS message for forwarding to an operating system or basic input/output system (BIOS).

Referring back to step 508, if the DRS-to-FRS conversion enable bit 218 is not set, the method 500 proceeds to step 514. In step 514, switch 210 does not convert the received DRS message to an FRS message. In step 516, root complex 202 probes switch 210 and discovers a ready PCIe device 220 by noticing that the DRS message received bit 218 is set.

In sum, in order to notify the root complex when PCIe endpoint devices become available, PCIe endpoint devices are configured to send readiness notification messages, including a Function-Ready-Status (FRS) message and a Device-Ready-Status (DRS) message. A PCIe endpoint device may be configured to send an FRS message when a function of the PCIe endpoint device becomes available. A PCIe endpoint device may also be configured to send a DRS message when all functions of the PCIe endpoint device become available. When the DRS message is received by the switch to which the PCIe endpoint device is coupled, the switch sets a “DRS message received” bit indicating that the switch has received the DRS message.

A PCIe endpoint device may become available before the PCIe endpoint device is enumerated, and therefore before the PCIe endpoint device has an address or ID. Without an address or ID, a DRS message may not be able to indicate the identity of the device that has become ready to the root complex. Thus, a downstream port in the switch that receives the DRS message may be configured to convert the DRS message into an FRS message. The converted FRS message includes an indication that the FRS message is the result of a DRS-to-FRS conversion and also includes the requestor ID of the downstream port that sends the FRS message. The combination of the DRS-to-FRS conversion indication and the requestor ID of the downstream port allows the root complex to identify that the PCIe endpoint device that sent the DRS message is the PCIe endpoint device that is coupled to the downstream port of the switch.

If DRS-to-FRS conversion is not enabled in the switch, then the DRS message received bit corresponding to the downstream port that received the DRS message is still set, but no FRS message is sent. Subsequently, when the root complex communicates with the switch, the switch indicates to the root complex that the switch has received a DRS message corresponding to the PCIe endpoint device coupled to the downstream port that corresponds to the DRS message received bit.

An advantage of the techniques provided herein is that a PCIe endpoint device can send a readiness notification to the root complex before the PCIe endpoint device has been enumerated. A further advantage is that the PCIe endpoint device can notify a root complex that the PCIe endpoint device is ready prior to the expiration of the delay period. Yet another advantage is that a PCIe endpoint device can notify a root complex that the PCIe endpoint device is ready without requiring the root complex to poll the PCIe endpoint device.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A computer-implemented method for sending readiness notification messages to a root complex, the method comprising:
receiving a device-ready-status (DRS) message in a downstream port that is coupled to an upstream port in a peripheral component interconnect express (PCIe) component; and
setting a bit in the downstream port indicating that the DRS message has been received.

2. The method of claim 1, wherein the DRS message is configured as a link-local routing message.

3. The method of claim 1, further comprising:
determining that device-ready-status-to-function-ready-status (DRS-to-FRS) conversion is enabled in the downstream port; and
generating a function-ready-status (FRS) message in response to receiving the DRS message.

4. The method of claim 3, wherein the FRS message is configured as a route-to-root message.

5. The method of claim 4, wherein the FRS message includes a requestor identifier associated with the downstream port.

6. The method of claim 5, wherein the FRS message includes an indication that the FRS message is the result of a DRS-to-FRS conversion.

7. The method of claim 6, further comprising transmitting the FRS message to a root complex.

8. The method of claim 7, further comprising queuing the FRS message in the root complex for transmission to one or more of system software and firmware.

9. The method of claim 8, wherein the FRS message is configured as a type-1 vendor defined message.

10. A peripheral component interconnect express (PCIe) subsystem comprising downstream port configured to:
receive a device-ready-status (DRS) message from an upstream port in a component that is coupled to the downstream port; and
set a bit in the downstream port indicating that the DRS message has been received.

11. The PCIe subsystem of claim 10, wherein the DRS message is configured as a link-local routing message.

12. The PCIe subsystem of claim 10, wherein the switch is further configured to:
determine that device-ready-status-to-function-ready-status (DRS-to-FRS) conversion is enabled in the downstream port; and
generate a function-ready-status (FRS) message in response to receiving the DRS message.

13. The PCIe subsystem of claim 12, wherein the FRS message is configured as a route-to-root message.

14. The PCIe subsystem of claim 13, wherein the FRS message includes a requestor identifier associated with the downstream port.

15. The PCIe subsystem of claim 14, wherein the FRS message includes an indication that the FRS message is the result of a DRS-to-FRS conversion.

16. The PCIe subsystem of claim 15, wherein the downstream port is further configured to transmit the FRS message to a root complex.

17. The PCIe subsystem of claim 16, wherein the FRS message is configured as a vendor defined message.

18. The PCIe subsystem of claim 17, wherein the FRS message is configured as a type-1 vendor defined message.

19. A computing device comprising:
a peripheral component interconnect express (PCIe) subsystem comprising:
a downstream port configured to:
receive a device-ready-status (DRS) message from an upstream port in a component that is coupled to the downstream port; and
set a bit in the downstream port indicating that the DRS message has been received.

20. The computing device of claim 19, wherein the downstream port is further configured to:
determine that device-ready-status-to-function-ready-status (DRS-to-FRS) conversion is enabled in the downstream port; and
generate an FRS message in response to receiving the DRS message.
